(19) United States
(12) Patent Application Publication
(10) Pub. No.: US 2003/0085051 A1
(43) Pub. Date: May 8, 2003

(54) Device for the electrically conductive contacting of a coaxial cable's outer conductor stripped by section

(76) Inventor: Britta Daume, Burgwedel (DE)

Correspondence Address: SHLESINGER, ARKWRIGHT & GARVEY LLP, 3000 South Eads Street, Arlington, VA, 22202, US

(21) Appl. No.: 10/217,422

(22) Filed: Aug. 14, 2002

(30) Foreign Application Priority Data
Aug. 16, 2001 (DE) 201 13 219.2

(51) Int. Cl. H02G 15/02

(52) U.S. Cl. 174/75 C

(57) ABSTRACT

A device (2) for electrically conductive contacting of a sectionally stripped outer conductor (24) of a coaxial cable (26) and which is set back radially with respect to a sheath (28) of the coaxial cable (26), the device comprising a base element (4) in the form of a clamp which can clamped around the coaxial cable (26). The device (2) furthermore has a seal (22), in particular formed by sealing lips, with which, in the installed position of the device, the base element (4) lies sealingly on the sheath (28) of the coaxial cable (26) and contact means for establishing an electrically conductive connection between the outer conductor (24) of the coaxial cable (26) and a conductor, e.g. a grounding cable. According to the invention, the seal (22) consists of at least one strip of a plastically or elastically deformable seal material which is held on the radial inner surface of the base body (4) and extends, on the radial inner surface of the base body (4) along the circumference of a contact area in which the contact means are in electrically conductive connection with the outer conductor (24) of the coaxial cable (26), essentially without interruption around the contact area in such a way that, when in the installed position of the device (2), the contact area is sealed against the penetration of air and/or moisture.

The device according to the invention is simple and economical to manufacture and easy to install.

The invention relates to a device of the type stated in the preamble of claim 1 for contacting in an electrically conductive manner a sectionally stripped outer conductor of a coaxial cable.

Devices of this type are generally known, for example, from EP 0 744 788 B1, EP 0 987 483 B1, and EP 0 978 678B1.

EP 0 982 524 B1 teaches a device of the type concerned here for contacting a sectionally stripped outer conductor of a coaxial cable in an electrically conductive manner, the conductor being set back radially with respect to the sheath of the coaxial cable, and the device having a base element formed as a clamp which can be clamped around the coaxial cable. The known device furthermore has a seal formed by sealing lips with which, in the installed position of the device, the base element abuts sealingly against on the sheath of the coaxial cable. In the case of the device known from the document, the base element has a metal clamp band which is imbedded in elastic material which forms the sealing lips on the side facing the coaxial cable in the installed position. The sealing lips are thus formed on the elastic material of the base element. The known device furthermore has contact means for establishing an electrically conductive connection between the outer conductor of the coaxial cable and a conductor, e.g. a grounding cable.

The device known from the document, achieves a reliable seal of a contact area in which the contact means are in electrically conductive connection with the outer conductor of the coaxial cable, as well as a reliable electrically conductive contact between the contact means and the outer conductor. Moreover, the device known from the document can be manufactured in a simple and economical manner.

The objective of the invention is to provide a device of the type stated in the preamble of claim 1 whose manufacture is further simplified and thus can be manufactured more economically.

This objective is achieved by the teaching specified in claim 1.

According to the invention, the seal consists of at least one strip of a plastically or elastically deformable sealing material that is held on the radial interior surface of the base element and extends thereon along the circumference of a contact area, in which the contact means is in electrically conductive connection with the outer conductor of the coaxial cable, essentially without interruption around the contact area.

In this manner reliable sealing is achieved without the need for seals which are formed on an elastic part of the base element. As a result, in the case of the device according to the present invention a part of elastic material on which the sealing lips are formed is no longer required. In this manner the manufacture of the device according to the invention is further simplified and thus structured more economical.

A significant advantage of the device according to the invention consists of the fact that it is particularly simple in design. Moreover, the device according to the invention can be installed simply. In the simplest instance, the device according to the invention merely consists of a sheet metal part, which forms the base element, and the seal. Thus it can be manufactured particularly economically.

An extremely advantageous further development of the device according to the invention provides that the base element comprises a clamp band of electrically conductive material on which at least one contact projection is formed as a single piece and with the clamp band formed of electrically conductive material which, in the installed position of the device, projects, in the radial direction of the coaxial cable, over the sealing lips in such a way that it lies on the outer conductor of the coaxial cable and thus forms the contact means. In this embodiment the design of the device of the invention is further simplified since a separate contact element which forms the contact means is no longer required, but rather, the contact means are integrated into the clamp band. Thus, in this embodiment the device can consist in the simplest instance solely of the clamp band, the seal and means for tensioning the clamp band around the coaxial cable.

An advantageous development of the previously cited embodiment provides that the, or each, contact projection is formed by a tongue projecting toward the side of the base element facing the body to be contacted when in the assembled position. This embodiment is especially simple in design and thus can be economically manufactured.

In order to further simplify manufacture further it is advantageous in the previously cited embodiment that the, or each, tongue is stamped out or cut out of the clamp band.

An advantageous further development of the previously cited embodiment provides that openings created by forming the tongues in the clamp band are covered by a cover disposed on the radial outer side of the clamp band in such a manner that the openings are closed and penetration of air and/or moisture through the openings into the contact area is avoided. The covering can be formed for example by a coating, a strip of elastic material, or by other structural component closing the openings.

However, if required, the contact means can also comprise a separate contact element that can be connected to the base element.

In order to design such a contact element in a simple and economical manner, a further development of the previously cited embodiment provides that the contact element consists of a stranded wire or of a woven band consisting of metal or of profiled metal sheeting.

Another advantageous further development provides that the base element is formed as one piece and is open in the circumferential direction and includes bent or angled tabs that can be connected to each other when in the assembled position by at least one screw. In this embodiment assembly of the device according to the invention is especially simple.

An extremely advantageous further development of the previously cited embodiment provides means for limiting the screw-in path of the screw in such a manner that a compression of the seal takes place when the screw is tightened. This prevents too slight or too strong a compression of the seal during assembly of the device so that especially reliable sealing is achieved.

The seal can consist of any plastically or elastically deformable material. Further embodiments provide that the seal consists of an elastomer and/or butyl or similar elastically deformable material. Such seals can be manufactured in a simple and economical manner.

The invention is described in more detail as follows and with reference to the accompanying, highly schematic drawings.

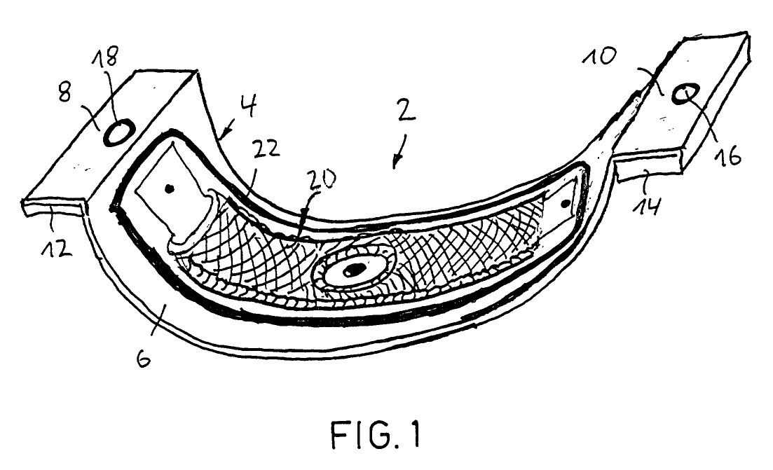

FIG. 1 shows a perspective view of an embodiment of a device according to the invention,

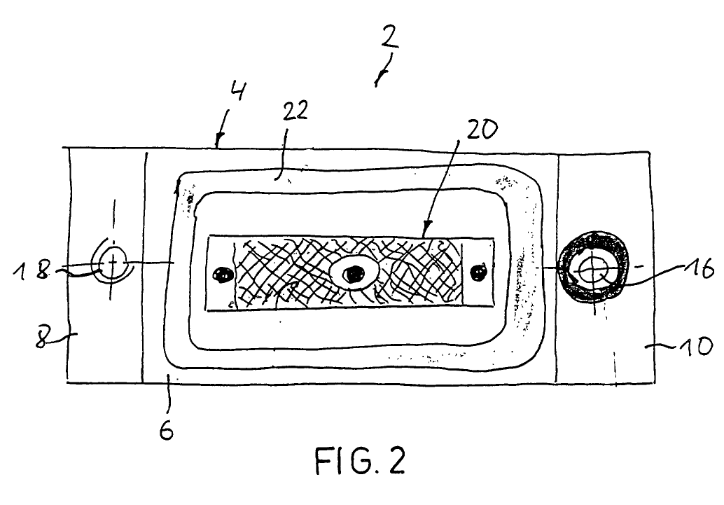

FIG. 2 shows a view of the radial inner surface of the device according to FIG. 1,

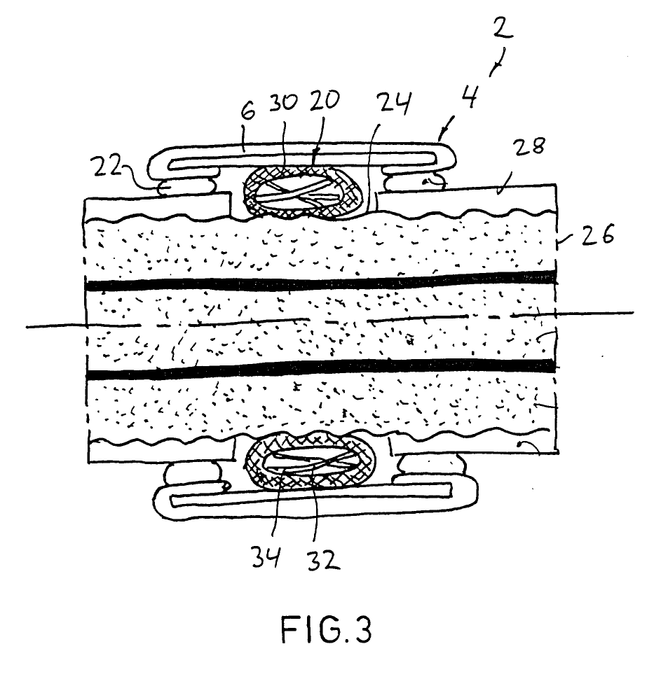

FIG. 3 shows an axial section through the device according to FIG. 1 when in the assemble position and

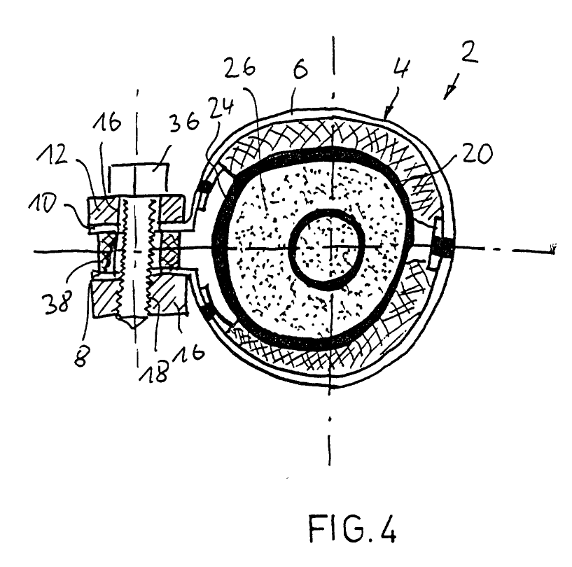

FIG. 4 shows a radial section through the device according to FIG. 1 when in the assembled position.

FIG. 1 shows an embodiment of a device 2 according to the invention for contacting of a sectionally uninsulated outer conductor of a coaxial cable (not shown FIG. 1) in an electrically conductive manner. The device 2 comprises a base element 4 which is formed in this embodiment by a metal clamp band 6 which has, at its ends, tabs 8 and 10 which are bent and provided with reinforcements 12 and 14. Tabs 8 and 10 can be connected to one another by means of a screw (not shown in FIG. 1) extending in the assembled position through a through-bore formed in tab 10 and is screwed into a threaded bore 18 formed in the tab 8.

Device 2 also comprises contact means for establishing an electrically conductive connection between the clamp band 6 and a conductor, e.g. a grounding cable, said contact means having, in the case of this embodiment example, a separate contact element 20 which is explained in more detail below with reference to FIG. 3.

Seal 22 is provided for sealing of a contact area in which contact element 20 abuts against the outer conductor of the coaxial cable when device 2 is in the assembled position. In this embodiment, the seal consists only of a butyl strip which is held on the radial inner surface of the clamp band 6 and extends without interruption along the circumference of the contact element 20 around the contact element 20 in such a way that the contact area is sealed against the penetration of air and/or moisture when in the assembled position. Instead of a butyl strip or another sealing material, several strips can also be used which are consecutive in the circumferential direction of the contact element and are adjacent to one another without interruption and thus continuously surround the contact area.

FIG. 2 shows a view of the radial inner surface of device 2.

The assembly of the device 2 is explained in more detail with reference to FIG. 3. To connect an outer conductor 24 of a coaxial cable 26 to the grounding cable (not shown), a short length of sheath is removed from the coaxial cable 26 in the axial direction. Following this, the clamp band 6 is placed around the coaxial cable 26 in such a manner that the seal 22 comes to abut against sheath 28 of the coaxial cable. As can be seen from FIG. 3, the contact element 20 projects in a radial direction to such an extent beyond the seal that, with the seal 22 lying against the sheath 28, it comes to abut against the stripped outer conductor 24 of the coaxial cable 26 and in this manner establishes an electrically conductive connection between the outer conductor 24 and the clamp band 6. Since the clamp band 6 consists of metal, for example, a grounding cable can be connected to the clamp band 6 so that the outer conductor 24 of the coaxial cable 26 is grounded in the desired manner.

In this embodiment, the contact element 20 consists of the tubular, metal stranded wire 30 in whose interior a part 32 of profiled sheet metal is accommodated which has tongues 34 that are formed in an elastically resilient manner and thus bias the stranded wire 30 on one side against the radial inner surface of the clamp band 6 and on the other side against the outer conductor 24 of the coaxial cable 26 so that a secure electrically conductive connection between the clamp band 6 and the outer conductor 24 is obtained.

To tension clamp band 6 onto the coaxial cable 26 as represented in FIG. 4, a screw 36 is used which extends through the through-hole 16 and is screwed into the tapped hole 18 so that on tightening the screw 36 the clamp band 6 is clamped onto the coaxial cable. When tightening the screw 36, on one hand seal 22 is compressed between the clamp band 6 and the sheath 28 and on the other hand, the contact element 20 is compressed between the radial inner surface of the clamp band 6 and outer conductor 24. Since the seal 22 extends without interruption along the circumference of the contact element 20, a contact area, in which the contact element 20 abuts against the outer conductor 24 of the coaxial cable 26, is sealed against the penetration of air and/or moisture.

Furthermore, the device 2 has means for limiting the screw-in path of the screw 36 which, in the case of this embodiment example, are formed by a spacer bushing 38 which, in the installed position, is disposed between the surfaces of the tabs 8 and 10 facing one another, as shown in FIG. 4. The spacer bushing 38 bounds the screw-in path of the screw 36 in accordance with its axial length so that on tightening of the screw 36 compression of the seal 6 occurs in a defined manner. In this way too weak or too strong tightening of the screw is prevented and due to the defined compression of the seal 22, secure sealing is obtained.

Instead of a separate contact element 20, contact means can be provided which are integrated into the clamp band 6. For example, tongues extending from the clamp band in the axial and/or circumferential directions are stamped out are cut out, the tongues projecting toward the outer conductor 24 and abutting against it. With regard to the structure of these contact means formed as one piece with the clamp band 6, refer to EP 0 982 524 B1 whose disclosure is hereby included in full by reference within the present application.

If the contact means are formed by tongues stamped out or cut out of the clamp band 6, a cover is provided on the radial outer surface of the clamp band 6. The cover, for example, may consist of a strip of elastic material to sealingly cover openings formed in the clamp band by the tongues and thus prevent penetration of air and/or moisture through the openings and into the contact area.

I claim:

1. A device for the electrically conductive contacting of a coaxial cable's sectionally stripped outer conductor which is set back radially with respect to a sheath of the coaxial cable, with a base element formed as a clamp which can be clamped around the coaxial cable,
with a seal, in particular formed by sealing lips, with which, in the installed position of the device, the base element lies sealingly on the sheath of the coaxial cable, and
with contact means for establishing an electrically conductive connection between the outer conductor of the coaxial cable and a conductor, e.g. a grounding cable
characterized by the fact
that the seal (22) consists of at least one strip of a plastically or elastically deformable sealing material, which is, or are, held on the radial inner surface of the base element (4) and extends, on the radial inner surface of the base body (4) along the circumference of a contact area in which the contact means are in electrically conductive connection with the outer conductor (24) of the coaxial cable (26), essentially without interruption around the contact area in such a way that, in the installed position of the device, the contact area is sealed against the penetration of air and/or moisture.

2. Device according to claim 1, characterized by the fact that the base element (4) has a clamp band (6) of electrically conductive material, on which is formed at least one contact projection of electrically conductive material, formed as one piece with the clamp band, and, in the installed position of the device (2), projecting, in the radial direction of the coaxial cable (26), over the seal in such a way that it abuts against the outer conductor (24) of the coaxial cable, and thus forms the contact connection.

3. Device according to claim 2, characterized by the fact that the, or each, contact projection is formed by a tongue projecting toward the side of the base element (4) facing the coaxial cable (26) in the installed position.

4. Device according to claim 3, characterized by the fact that the, or each, tongue is stamped out are cut out of the clamp band (6).

5. Device according to claim 4, characterized by the fact that openings arising in the clamp band (6) by forming the tongues are covered by a covering disposed on the radial outer side of the clamp band (6) in such a way that the openings are closed and the penetration of air and/or moisture through these openings into the contact area is avoided.

6. Device according to claim 1, characterized by the fact that the contact means have a separate contact element (20) held on the base element (4).

7. Device according to claim 6, characterized by the fact that the contact element (20) consists of a litz wire or of a mesh band of metal or of profiled sheet metal.

8. Device according to claim 1, characterized by the fact that the base element (4) is formed as one piece and open in the circumferential direction and has, at its two ends, tabs (8, 10) which are angled off or bent and which, in the installed position of the device (2), can be connected to one another by means of at least one screw (36).

9. Device according to claim 8, characterized by the fact that means for limiting the screw-in path of the screw (36) are provided in such a way that on tightening of the screw (36) compression of the seal (22) occurs in a defined manner.

10. Device according to claim 1, characterized by the fact that the seal (22) consists of an elastomer.

11. Device according to claim 1, characterized by the fact that the seal (22) consists of butyl, or a like plastically deformable sealing material.
